(19) United States
(12) Patent Application Publication
(10) Pub. No.: US 2004/0151286 A1
(43) Pub. Date: Aug. 5, 2004

(54) Self-contained single telephone line voice and internet device with DTMF generation capability

(76) Inventor: Shary Nassimi, Vancouver, WA (US)

Correspondence Address: The Law Office of Craig W. Barber, PO Box 16220, Golden, CO, 80402-6004, US

(21) Appl. No.: 10/355,762

(22) Filed: Jan. 31, 2003

(51) Int. Cl. H04M 1/64

(52) U.S. Cl. 379/88.17

(57) ABSTRACT

The present invention provides a self-contained device for using a single telephone line to receive telephone calls while being simultaneously connectable to the Internet that avoids the disadvantages of the prior art, and a self-contained device for using a single telephone line to receive telephone calls while being simultaneously connectable to the Internet that is simple to use and yet may function in telephone systems which require DTMF codes in order to activate “call waiting” features. The present invention further provides a self-contained device using a single telephone line to receive telephone calls while being simultaneously connectable to the Internet. The device includes a single housing, a telephone/answering machine jack connected to a telephone/answering machine, a modem jack connected to a computer, a telephone line jack connected to a telephone outlet, a micro-processor and tone detectors communicating with the micro-processor, a DTMF tone generator operatively connected to and under the control of the micro-processor, telephone line isolation and input amplification and filtration communicating with, and between, the tone detectors and the telephone line jack, a tone select communicating with the tone detectors, display and ring buzzer communicating with the micro-processor, a ring voltage generator, a status detect (on/off hook) communicating with the micro-processor, control relays communicating with the status detect (on/off hook), and output drivers communicating with the micro-processor.

In a method embodiment, the invention teaches that DTMF tones may be used to activate call waiting and thus avoid interruption of Internet access on a single telephone line when an incoming call arrives.

### FIELD OF THE INVENTION

The present invention is a self-contained device for using a single telephone line to receive telephone calls and furthermore to generate DTMF tones as necessary to provide this service. More particularly, the present invention teaches that a self-contained device for using a single telephone line to receive telephone calls and use DTMF signals while being simultaneously connectable to the Internet.

### BACKGROUND OF THE INVENTION

Numerous innovations for telecommunication devices have been provided in the prior art that will be described. Even though these innovations may be suitable for the specific individual purposes to which they address, however, they differ from the present invention.

A FIRST EXAMPLE, U.S. Pat. No. 4,639,553 to Kiguchi teaches a facsimile communication system wherein a call signal detecting device is for identifying call signals which are received over a network. Both an unsounding call signal and a sounding call signal are detected by a single detection circuitry, which is also responsive to off-hooking of an own station's telephone set. Detection of such signals is implemented by the measurement of a period which is performed by a processing unit, so that changes in the specifications of the signals to be detected can be accommodated merely by modifying a program of the processing system and not the hardware of the device.

A SECOND EXAMPLE, U.S. Pat. No. 4,856,049 to Streck teaches apparatus for answering an incoming call over a single telephone line and for automatically switching the call between a telephone and a carrier signal-based device as appropriate. There is a three position switch for switching a telephone line connected thereto between first, second and third output positions thereof. The switch has the telephone operably connected to the second output position thereof and the carrier signal-based device connected to the third output position thereof. There is first logic having an input connected to the first output position of the switch and an output operably connected to switch the switch between the first, second and third output positions for answering an incoming call on the telephone line, for determining whether the incoming call is from a carrier signal-based device, for switching the switch to connect the second output position when an incoming call from a non-carrier signal-based device is detected, and for switching the switch to connect the third output position when an incoming call from a carrier signal-based device is detected. There is also second logic having an input connected to sense transmissions from the telephone and the carrier signal-based device and an output operably connected to switch the switch between the first, second and third output positions for switching the switch to the first position when a hang up by the telephone or the carrier signal-based device is detected. The preferred embodiment also senses a pickup by either device and automatically switches the switch to connect the device to the telephone line for outgoing transmission use. The preferred stand alone version also includes telephone answering capability for alerting a caller to its operation and for recording a message if the telephone is not answered.

A THIRD EXAMPLE, U.S. Pat. No. 5,003,581 to Pittard teaches a control and switching unit used with at least two devices for transmitting information or voice communication over telephone lines. The control and switching unit is provided with a series of relay to ensure that only one of the devices receives or transmits information at any one time. A timing circuit is utilized such that if one of the devices is a telephone, the second device would not be able to gain access to the telephone line if the telephone is ringing. Additionally, if the telephone is in use, the secondary device, such as a modem, could be selected and this secondary device would gain access to the telephone line after the use of the telephone has been discontinued.

A FOURTH EXAMPLE, U.S. Pat. No. 5,036,534 to Gural teaches a subscriber's interface enabling the connection of otherwise incompatible telephone device systems (hereinafter “(Z)”) to a single telephone line, each telephone device system having devices such as: a computer modem (hereinafter “(F)”), an automatic answering machine (hereinafter “(A)”), and telephone sets (hereinafter “(T)”). When a ring signal is received from the central office, the interface allows a first device, such as (A) or (T) to answer the call, and monitors the communication between the calling party and the first device bearing in mind its various operating modes. Based on the monitored conversation, the interface determines if the call should be connected to a second device. If so, an actuating signal is sent to (F), whereupon when (F) becomes OFF HOOK, it is connected to the telephone line. If the first device is an automatic answering machine, its various operating modes include: outgoing message, incoming message, beeperless remote mode. If the first device is a remotely located telephone set, its various mode of operation include simple human voice signals and complex human voice signals.

A FIFTH EXAMPLE, U.S. Pat. No. 5,392,334 to O'Mahoney teaches a method for processing an incoming call on a telephone line in a computer system, wherein a telephony circuit detects a pick-up by a parallel device coupled to the telephone line while maintaining high voltage isolation. The telephony circuit performs hard line seizures to cause the parallel device to hang-up and soft line seizures to prevent a central office hang up after the parallel device hangs up.

A SIXTH EXAMPLE, U.S. Pat. No. 5,519,767 to O'Horo et al. teaches a call-waiting feature that is supported on voice-and-data modems by causing voice-and-data modems to go into voice-only mode upon receipt of the modem clear-down signal. A first voice-and-data modem engaged in an initial voice-and-data call with a second voice-and-data modem responds to receipt of a call-waiting signal by generating a replica of the call-waiting signal on the user's audio channel. The first modem responds to a user request to pick up the waiting call by sending the modem clear-down signal to the second voice-and-data modem, going into voice-only mode, and transmitting a waiting-call acceptance signal. The initial call that is placed on hold is thus a voice-only call. While in a voice-plus-data picked-up waiting call, the first modem responds to a user request to reinstate the initial call by again sending the modem clear-down signal, going into voice-only mode, and transmitting a call-resumption signal. The first modem is thus in voice-only-mode when it is reconnected to the initial, voice-only, call. The reconnected initial call may now be reconverted into a voice-plus-data call in the convention manner.

A SEVENTH EXAMPLE, U.S. Pat. No. 5,809,128 to McMullin teaches methods and apparatus for providing automatic redirection of an incoming voice telephone call from a caller to a subscriber proxy when an attempt by the caller to connect to a telephone link of a public switched telephone network (PSTN) is blocked due to the telephone link being occupied by a subscriber using the telephone link to establish communication between the subscriber's personal computer and a computer network. The subscriber proxy is connected to both the PSTN and the computer network, and produces audio interaction with the caller. The subscriber proxy also notifies the subscriber of the incoming call via the subscriber's computer. The subscriber's computer can optionally be used by the subscriber to control and interact with the incoming call by communicating with the computer proxy while the subscriber continues to occupy the telephone link.

AN EIGHTH EXAMPLE, U.S. Pat. No. 6,005,924 to Krexner et al. teaches a fax and phone combination device. The combination device is coupled to an external phone. From a phone line, the combination device receives a call signal, a fax signal, and an information signal. The call signal precedes the fax signal and the information signal. The combination device comprises a fax, an internal phone, and a call signal processor. The call processor processes the call signal received by the combination device and produces a first ringing signal from the call signal. The first ringing signal is intended for the internal phone. The combination device further comprises a ringing signal generator for generating a second ringing signal that is intended for the external phone, and a switch coupled to the fax, the internal phone, and the call processor. A call pulse in the call signal causes the switch to switch the combination device in a simulated receiving mode. In the simulated receiving mode, the fax signal detector detects whether the fax signal is present. If the fax signal is present, the fax signal is routed to the fax. If no fax signal is present, the second ringing signal is routed to the external phone.

A NINTH EXAMPLE, U.S. Pat. No. 6,067,353 to Szeliga teaches a method and related apparatus for detecting the presence of a call waiting signal on a telephone line, where the call waiting signal is embedded in various signals. The call waiting signal frequency is isolated from the various other frequencies. The isolated call waiting frequency is then biased so that only the positive voltage portions of the signal are allowed to pass. Each positive voltage pulse as well as the zero voltage pulses are then sampled to determine whether they are representative of a biased call waiting signal. Each time a determination is made, one is added to a count on an up-down counter. When the count reaches a predetermined number, a call waiting signal is detected on the telephone line. Preferably an alarm signals the presence of a detected call waiting signal to the user. A disconnect switch interrupts a modem so that a person using the modem on the same telephone line will have sufficient time to answer a detected incoming call.

A TENTH EXAMPLE, U.S. Pat. No. 6,259,353 to Berger et al. teaches a transponder communication device that interrogates an operational test transponder that is permanently within a receiving range of the transponder communication device. In response thereto, the operational test transponder sends operational test information to the transponder communication device. The transponder communication device checks whether received operational test information is valid, and generates an error signal if the received operational test information is invalid.

AN ELEVENTH EXAMPLE, U.S. Pat. No. 6,259,692 to Shtivelman et al. teaches a telephony call-waiting system for clients having a computer with a video display unit (PC/VDU) and a public-switched telephony network (PSTN) telephone connected to the PSTN by a single line, keeps a status indication of the client's Internet connection status and, during periods of time the PC/VDU is connected to the Internet, alerts the client by an alert signal over the Internet connection of any waiting PSTN calls. In a preferred embodiment the client's PC/VDU is adapted to provide an audio and/or visual alert event when an alert signal is received, and to provide for a user-initiated response to an alert, accepting or rejecting a call. In the event a call is accepted, provision is made for connecting the accepted call to the client's PC/VDU as an IP call. In some embodiments several calls may be dealt with at the PC/VDU, and features are provided such as caller-ID on the client's VDU. Several ways of accomplishing the call-waiting system are taught.

One important method of offering “call waiting” functionality is the provision by the central telephone exchange of a virtual ‘second line.’ The second line is accessed in many places by using the “flash” signal (comprising a quick depression of the switch hook). On receiving such a “flash” signal the central exchange, rather than disconnecting the connection, switches the connection to the virtual other line. This can be repeated as many times as necessary until the exchange receives a much longer depression of the switch hook (caused by one party hanging up a telephone).

However, not all exchanged operate in the same way. Some exchanges, for example those in the national telephone system of Mexico, require not only a “flash” but also a DTMF code in addition.

Though previous innovations may be suitable for the specific individual purposes to which they are addressed they would not be suitable for the purposes of the present invention as hereinafter described.

### SUMMARY OF THE INVENTION

General Summary

ACCORDINGLY, AN OBJECT of the present invention is to provide a self-contained device for using a single telephone line in an exchange which uses DTMF codes for “call waiting” features, and uses these to receive telephone calls while being simultaneously connectable to the Internet that avoids the disadvantages of the prior art.

ANOTHER OBJECT of the present invention is to provide a self-contained device for using a single telephone line to receive telephone calls while being simultaneously connectable to the Internet that is simple to use.

YET ANOTHER OBJECT of the present invention is to provide a self-contained device using a single telephone line to receive telephone calls even on telephone systems requiring both a flash and a DTMF tone for switching calls while being simultaneously connectable to the Internet. The device includes a single housing, a telephone/answering machine jack connected to a telephone/answering machine, a modem jack connected to a computer, a telephone line jack connected to a telephone outlet, a micro-processor and tone detectors communicating with the micro-processor, and a DTMF tone generator under the control of the micro-processor, telephone line isolation and input amplification and filtration communicating with, and between, the tone detectors, the DTMF tone generator, and the telephone line jack, a tone select communicating with the tone detectors, display and ring buzzer communicating with the micro-processor, a ring voltage generator, a status detect (on/off hook) communicating with the micro-processor, control relays communicating with the status detect (on/off hook), and output drivers communicating with the micro-processor.

The present invention is designed to provide an all-in-one solution for multiple devices present and operating on a single standard telephone line. The benefits include the ability to receive calls, whether online or not online and to remain online if already on line.

To achieve the combined functions, the present invention integrates a micro-processor which coordinates general functionality, as well as tone detection circuitry, which provides extremely narrow and selective detection range and detects the appropriate tones. Care is taken to assure a narrow enough detector design which will not false alarm or detect such sound as modem noise which is far stronger, louder, and full spectrum than the intended detection range, which includes a fax tone and a call waiting tone.

In addition, DTMF tone generation circuitry is included in order to provide for the generation of DTMF tones necessary in some national/local telephone exchange systems. Without this circuitry, the invention is not able to provide “call waiting” features, an important part of the entire concept allowing use of a single telephone line for both computer and voice communications, without interruption of the computer connection.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

Summary in Reference to Claims

It is therefor a first aspect, advantage, objective and embodiment of the present invention to provide a self-contained device for using a single telephone line to receive telephone calls to a telephone/answering machine while being simultaneously connectable to the Internet by a computer having a modem, said device comprising: a single housing having a wall and a microprocessor; a telephone/answering machine jack located on the wall of the single housing; a modem jack located on the wall of the single housing; a telephone line jack located on the wall of the single housing; a DTMF tone generator able to generate DTMF tones on the such single telephone line; a display located on the single housing.

It is therefor another aspect, advantage, objective and embodiment of the present invention to provide a device wherein the DTMF tone generator is operatively connected to and controlled by the micro-processor.

It is therefor yet another aspect, advantage, objective and embodiment of the present invention to provide a device further comprising: a power supply having an input, a cable and an AC transformer adapted to connect to an AC power source.

It is therefor yet another aspect, advantage, objective and embodiment of the present invention to provide a device wherein said power supply further has a 5 volt voltage regulator.

It is therefor yet another aspect, advantage, objective and embodiment of the present invention to provide a device further comprising at least one telephone line isolation, amplification and filtration device located within the single housing; wherein the DTMF tone generator is operatively connected to the telephone line via the telephone line isolation, amplification and filtration device.

It is therefor yet another aspect, advantage, objective and embodiment of the present invention to provide a device wherein the micro-processor responds to a user request for switching from one use of the telephone line to another use of the telephone line by generating the appropriate signals that the telephone exchange recognizes as requests to change lines.

It is therefor yet another aspect, advantage, objective and embodiment of the present invention to provide a device wherein the appropriate signals that the telephone exchange recognizes as requests to change lines are selected from the group comprising: switch hook flash signals, DTMF tones, and combinations thereof.

It is therefor yet another aspect, advantage, objective and embodiment of the present invention to provide a device wherein the appropriate signals that the telephone exchange recognizes as requests to change lines comprise: a switch hook flash signal followed by the DTMF tone corresponding to the number 2.

It is therefor yet another aspect, advantage, objective and embodiment of the present invention to provide a device wherein the micro-processor responds to receipt of telephone call rings by automatically handling an incoming call.

It is therefor yet another aspect, advantage, objective and embodiment of the present invention to provide a device wherein the automatic handling of the incoming call comprises one member selected from the group consisting of: suspending Internet access; routing the call to a telephone/answering machine; sending to the user the telephone call ring information in order to allow the user to manually determine handling of the call; ignoring the call; routing the call to a modem; and combinations thereof.

It is therefor yet another aspect, advantage, objective and embodiment of the present invention to provide a method of receiving a telephone call comprising the steps of: accessing a service provider by means of a telephone line having the call waiting feature; monitoring the telephone line using a stand alone device; upon receipt of a call waiting tone, determining if a call is to be answered; if the call is to be answered, carrying out the following steps 5 through 7 inclusive: flashing the telephone line, and following the flash by generating a DTMF tone on the telephone line, thereby automatically placing the service provider on hold and connecting to the caller; monitoring the telephone line using the stand alone device until the telephone is hung up; and flashing the telephone line, and following the flash by generating a DTMF tone on the telephone line, thereby automatically connecting to the service provider.

It is therefor yet another aspect, advantage, objective and embodiment of the present invention to provide a method further comprising the steps of: determining if the service provider has logged off of the computer; and reconnecting to the service provider.

It is therefor yet another aspect, advantage, objective and embodiment of the present invention to provide a method wherein the step of determining if a call is to be answered further comprises one member selected from the group consisting of: manually determining if the call is to be answered by awaiting user input, automatically determining if the call is to be answered by consulting information provided during the set-up of the device.

### BRIEF DESCRIPTION OF THE DRAWINGS

FIG. 1 is a diagrammatic perspective view of the present invention interfacing with associated inputs.

FIG. 2 is a block diagram of the present invention.

FIG. 3 is a flow chart of the method of switching between calls during operation of the present invention.

FIGS. 4A, 4B, 5 and 6 are a single flow chart of the overall method of operation of the present invention, during which use of DTMF tones occurs according to FIG. 3 occurs.

FIGS. 7A-7D are a flow chart of the method of installing the present invention.

FIGS. 8A-8C are a flow chart of the method of ascertaining that call waiting is not disabled for window users.

FIGS. 9A-9B are a flow chart of the method of ascertaining that calling waiting is not disabled for America-On-Line (AOL) users.

FIGS. 10A-10B are a flow chart of the method for ascertaining that call waiting is not disabled for Macintosh Computer (MAC) users.

FIGS. 11A-11D are a flow chart of the method of making the present invention work better with the computer if the computer disconnects as soon as the telephone/answering machine rings or as soon as the telephone/answering machine is answered.

### INDEX OF REFERENCE NUMERALS

10 self-contained device of present invention for using single telephone line 12 to receive telephone calls to a telephone/answering machine 14 while being simultaneously connectable to the Internet by computer 18

12 single telephone line

14 telephone/answering machine

18 computer

20 single housing

22 back wall of single housing 20

24 power supply input

25 cable

26 AC transformer for connecting to AC power source 28

28 AC power source

32 telephone/answering machine jack for connecting to telephone/answering machine 14

34 modem jack for connecting to computer 18

36 telephone line jack for connecting to telephone outlet 38

38 telephone outlet

40 caller ID device

41 power supply

42 micro-processor

43 5 volt voltage regulator of power supply 41

44 tone detectors

44b call waiting tone detector of tone detectors 44

44c DTMF tone generator 44

45 telephone line isolation and input amplification and filtration

46 tone select

48 ring display/buzzer

50 ring voltage generator

### DETAILED DESCRIPTION

The present invention makes use of the DTMF call waiting line switch signal offered as a feature by many telephone service providers, to allow simultaneous use of the Internet and the call waiting features. For purposes of this patent application, it will be understood that the terms DTMF, DTMF Tones, and the like are used interchangeably herein. In addition, “Internet Service Provider”, “ISP”, or just “service provider” and the like are used interchangeably herein.

In general, when a user is on-line, they will be enabled by the device of the invention to receive call waiting signals and then decide, either manually or automatically, whether they wish to break off their Internet session or ignore the telephone call, even in telephone exchange systems in which switching lines requires not just a ‘flash’ signal but also a DTMF code afterwards. As an example, in the national telephone system of Mexico, after the ‘flash’ switch hook signal, a DTMF tone corresponding to the number ‘2’ is required.

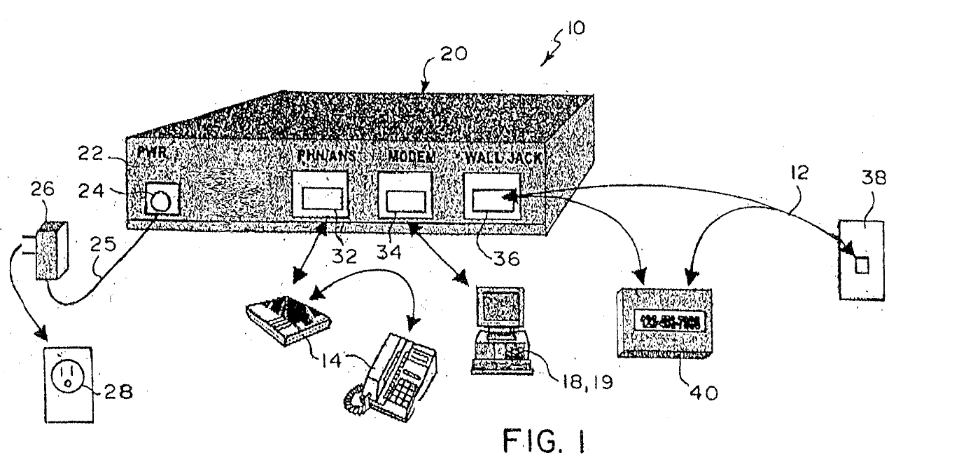

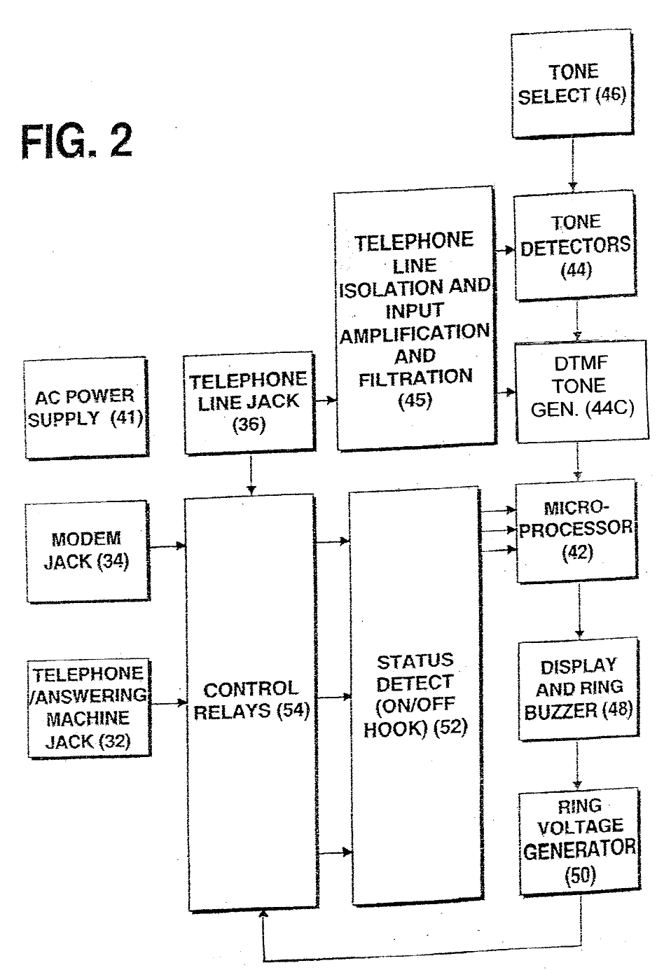

Referring now to the Figures, in which like numerals indicate like parts, and particularly to FIGS. 1 and 2, the self-contained device of the present invention is shown generally at 10 for using a single telephone line 12 to receive telephone calls for transmission to a telephone/answering machine 14 while being simultaneously connectable to the Internet by a computer 18 that has a modem 19.

The self-contained device 10 comprises a single housing 20 that has a back wall 22.

The self-contained device 10 further comprises a power supply input 24. The power supply input 24 is on the back wall 22 of the single housing 20 and is connected by a cable 25 to an AC transformer 26 for connecting to an AC power source 28.

The self-contained device 10 further comprises a telephone/answering machine jack 32. The telephone/answering machine jack 32 is on the back wall 22 of the single housing 20 and is for connecting to the telephone/answering machine 14.

The self-contained device 10 further comprises a modem jack 34. The modem jack 34 is on the back wall 22 of the single housing 20 and is for connecting to the computer 18.

The self-contained device 10 further comprises a telephone line jack 36. The telephone line jack 36 is on the back wall 22 of the single housing 20 and is for connecting to a telephone outlet 38. If a caller ID device 40 is used, the caller ID device 40 is connected between the telephone line jack 36 and the telephone outlet 38.

The self-contained device 10 further comprises a power supply 41. The power supply 41 is contained in the single housing 20 and communicates with the power supply input 24. The power supply 41 includes a 5 volt voltage regulator 43.

The self-contained device 10 further comprises a micro-processor 42. The micro-processor 42 is contained in the single housing 20 and makes most of the functional decisions. A typical example of the micro-processor 42 is Microchip PIC 16C54.

The self-contained device 10 further comprises tone detectors 44. The tone detectors 44 are contained in the single housing 20, communicate with the micro-processor 42, and include a call waiting tone detector 44b.

The self-contained device 10 further comprises DTMF tone generator 44c. DTMF tone generator 44c is contained within the single housing 20 of self-contained device 10, and may be an independent device, a part of micro-processor 42 or a part of tone detectors 20. Generator 44c may also be a software implementation running on micro-processor 42 within self-contained device 10. Such a software implementation may be modified and programmed via download from either a telephone line or from an attached computer, or may be modified and programmed by means of hardware on single housing 20: mode/function buttons, etc. Generator 44c creates on the telephone line DTMF tones such as are received and processed by the telephone exchange system.

The call waiting tone detector 44b is a tone detector with switched capacitor or digital signal processing (DSP) detection that detects a call-waiting tone and also discriminates between the call-waiting tone and modem noise present at that time. The call waiting tone detector 44b has selectable frequencies for different tones in other countries. A typical example of the call waiting tone detector 44b is Teltone M982-02.

The self-contained device 10 further comprises telephone line isolation and input amplification and filtration 45. The telephone line isolation and input amplification and filtration 45 are contained in the single housing 20 and communicate with, and between, the tone detectors 44 and the telephone line jack 36.

The self-contained device 10 further comprises a tone select 46. The tone select 46 is contained in the single housing 20 and communicates with the tone detectors 44.

The display and ring buzzer 48 are contained in the single housing 20 and communicate with the micro-processor 42. The micro-processor 42 generates tone for the display and ring buzzer 48.

The self-contained device 10 further comprises a ring voltage generator 50. The ring voltage generator 50 is contained in the single housing 20.

The jacks 30, 32, 34, and 36 are operatively connected so as to allow transmission of analog or digital information therebetween, thus allowing transmission of such information/data between the telephone line 12 and the various devices attached to the self-contained device 10. Micro-processor 42 is further able to direct incoming calls by means of the jacks 30, 32, 34, and 36 to such attached devices. Finally, micro-processor 42 and/or generator 44c is/are able to control the operation of display/buzzer 48.

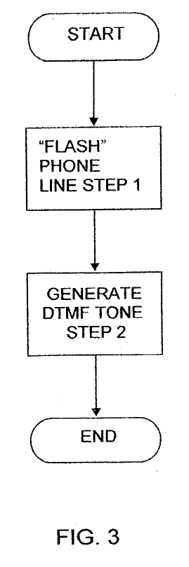

Referring now to FIG. 3, the method of use of DTMF codes for call switching will now be discussed. The steps in this process are as follows:

STEP 1: When switching from one call to another is desired, a switch hook “flash” is generated on the telephone line.

STEP 2: Generator 44c then generates a DTMF tone in order to complete the switch from the first call to the second call.

This basic process may be employed in any of the embodiments of the invention discussed below, at the step of detecting a ring signal and switching from Internet usage to the incoming call. The enhancements this offers will be further discussed in reference to each of the following embodiments.

In the preferred embodiment and best mode presently contemplated for carrying out the invention, microprocessor 42 will display using display 48 any ring signal which arrives.

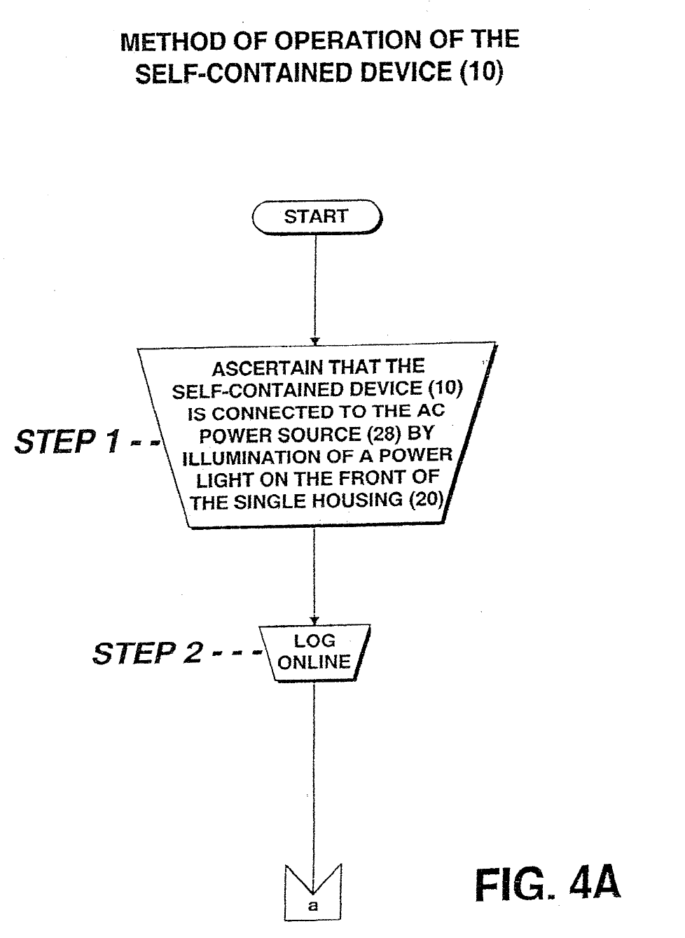

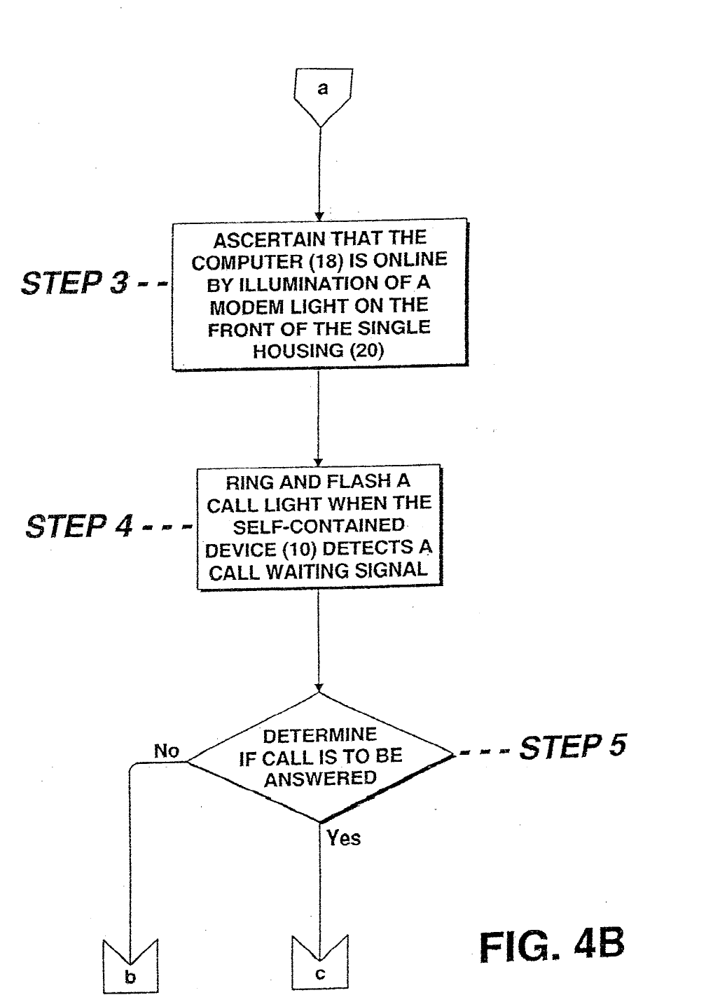

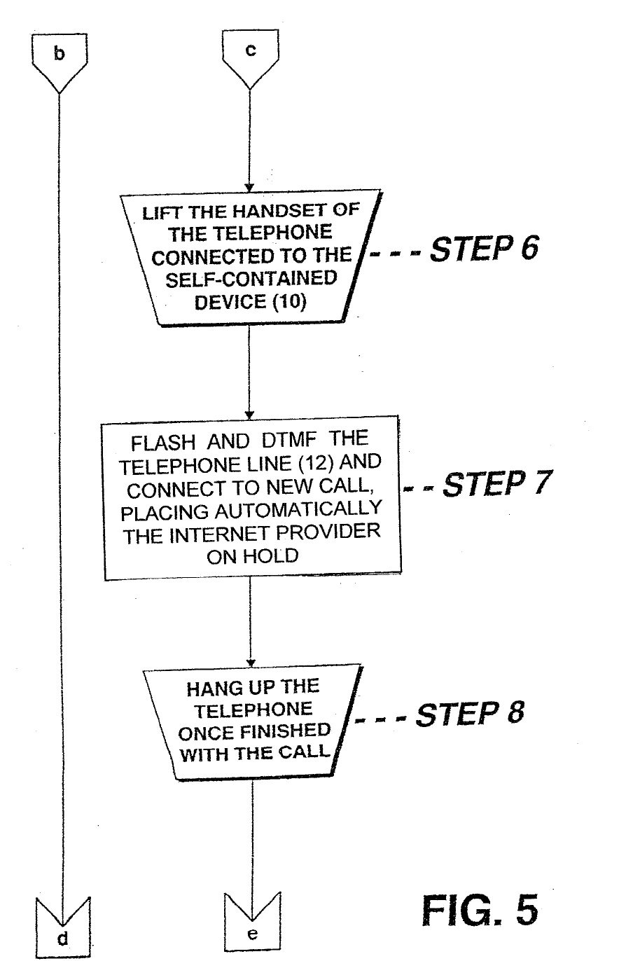

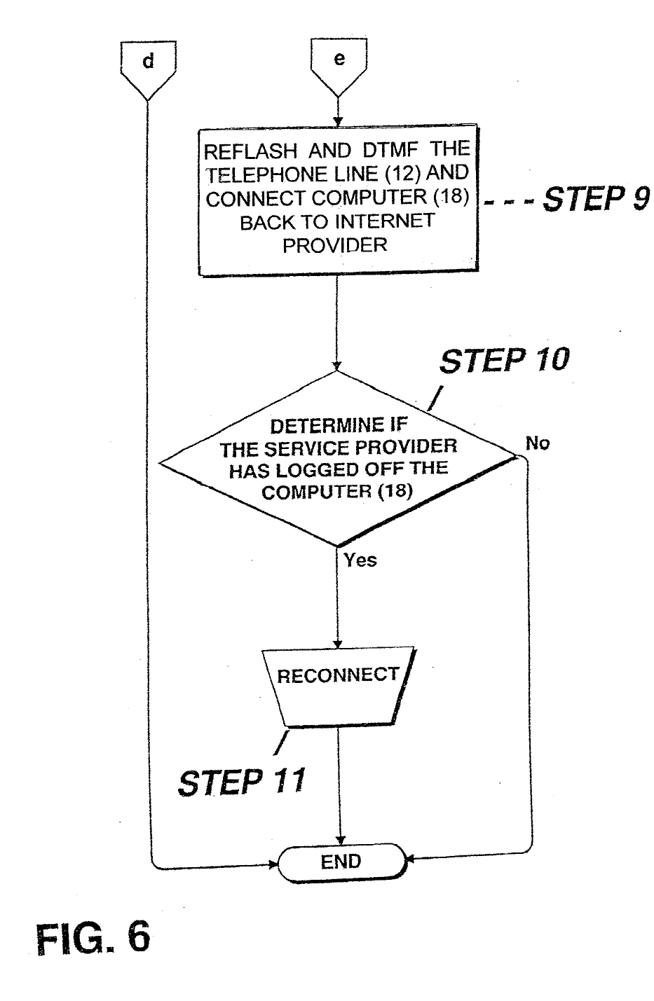

Referring now to FIGS. 4A, 4B, 5 and 6, the method of use of the device will now be discussed.

STEP 1: Ascertain that the self-contained device 10 is connected to the AC power source 28 by illumination of a power light on the front of the single housing 20.

STEP 2: Log online.

STEP 3: Ascertain that the computer 18 is online by illumination of a modem light on the front of the single housing 20.

STEP 4: Ring and flash a call light when the self-contained device 10 detects a call waiting signal.

STEP 5: Determine if call is to be answered.

STEP 6: Lift the handset of the telephone connected to the self-contained device 10, if answer to STEP 5 is yes.

STEP 7: Flash and DTMF tone automatically the telephone line 12 and connect to the new call, placing automatically the Internet provider on hold.

STEP 8: Hang up the telephone once finished with the call.

STEP 9: Reflash and DTMF tone automatically the telephone line 12 and connect the computer 18 back to the Internet provider.

STEP 10: Determine if the service provider has logged off the computer 18. It is not unusual for the Internet service provider to disconnect within a short period.

STEP 11: Reconnect, if answer to STEP 10 is yes.

During STEP 5, determination of whether the call should be answered or not, the user may manually determine whether or not to temporarily suspend the Internet session by means of the abilities offered by self-contained device 10. The handling of the incoming call may be determined automatically. For example, the user may program the device during set-up so as to automatically suspend Internet access in accordance with the invention.

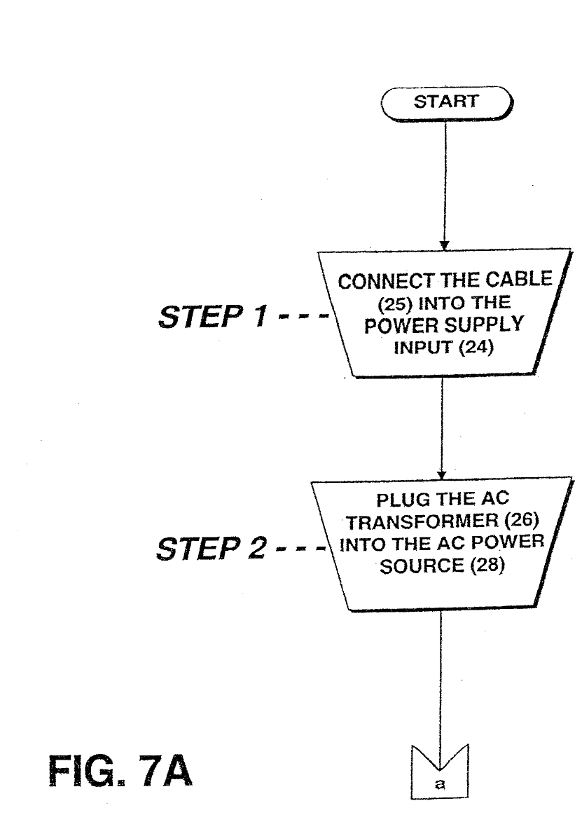

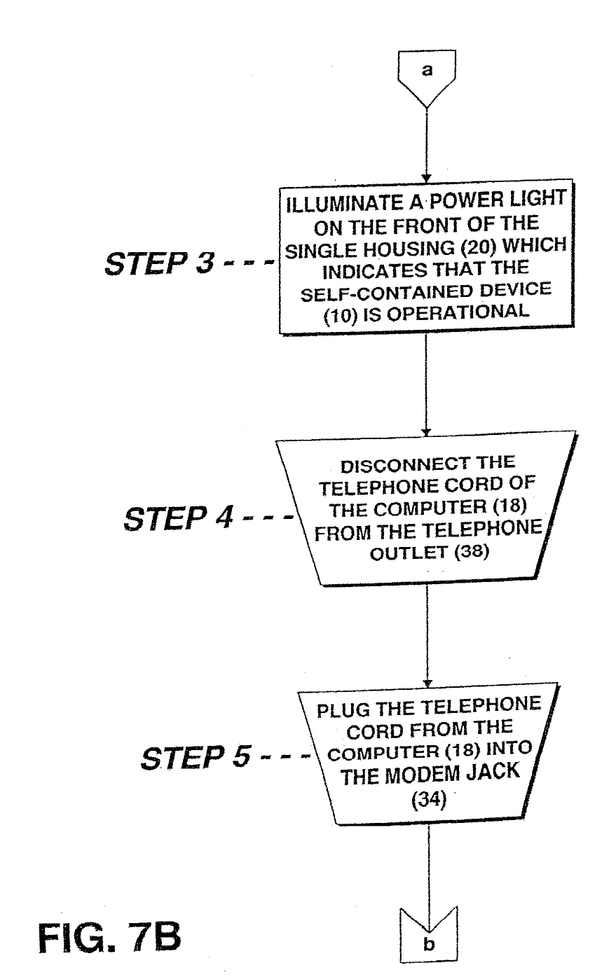

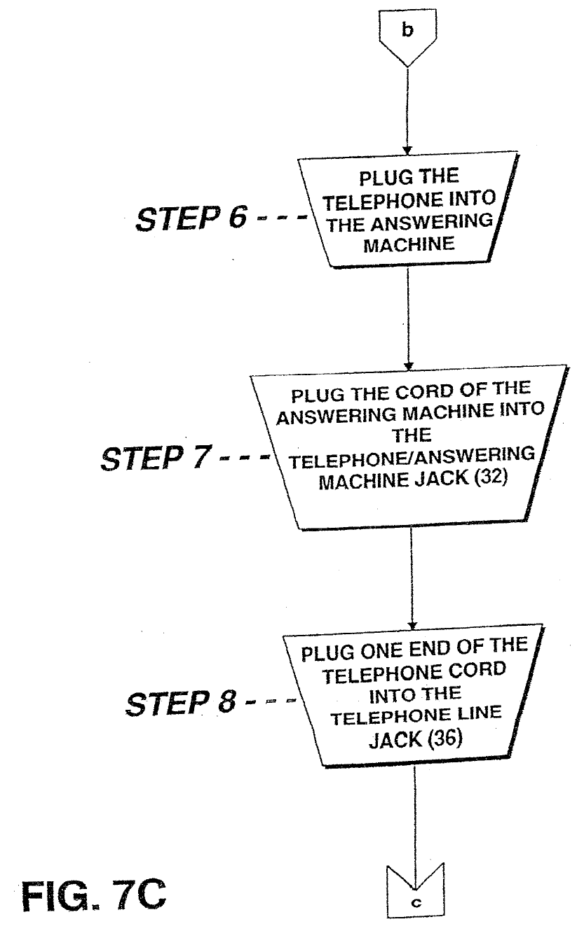

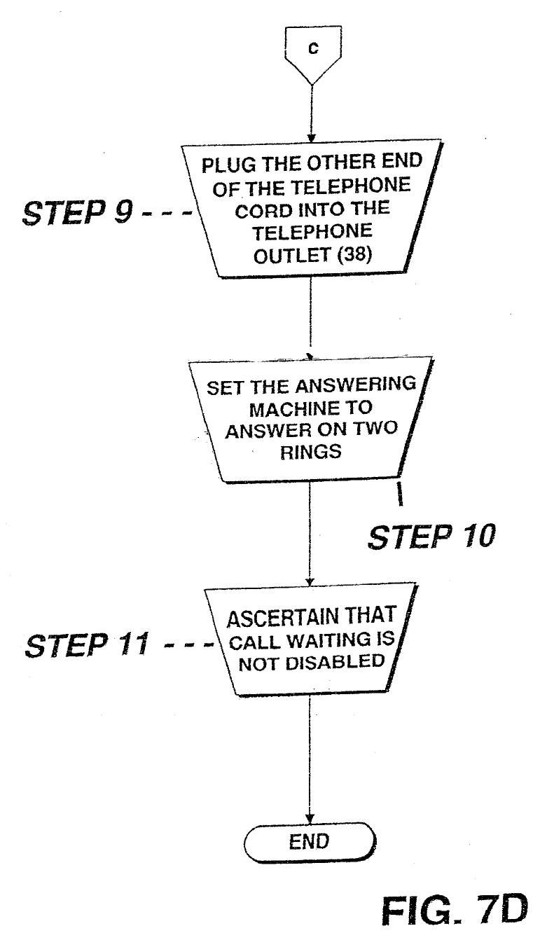

The method of installing the self-contained device 10 can best be seen in FIGS. 7A-7D, and as such, will be discussed with reference thereto.

STEP 1: Connect the cable 25 into the power supply input 24.

STEP 2: Plug the AC transformer 26 into the AC power source 28.

STEP 3: Illuminate a power light on the front of the single housing 20, which indicates that the self-contained device 10 is operational.

STEP 4: Disconnect the telephone cord of the computer 18 from the telephone outlet 38.

STEP 5: Plug the telephone cord from the computer 18 into the modem jack 34.

STEP 6: Plug the telephone into the answering machine.

STEP 7: Plug the cord of the answering machine into the telephone/answering machine jack 32.

STEP 8: Plug one end of the telephone cord into the telephone line jack 36.

STEP 9: Plug the other end of the telephone cord into the telephone outlet 38.

STEP 10: Set the answering machine to answer on two rings.

STEP 11: Ascertain that call waiting is not disabled.

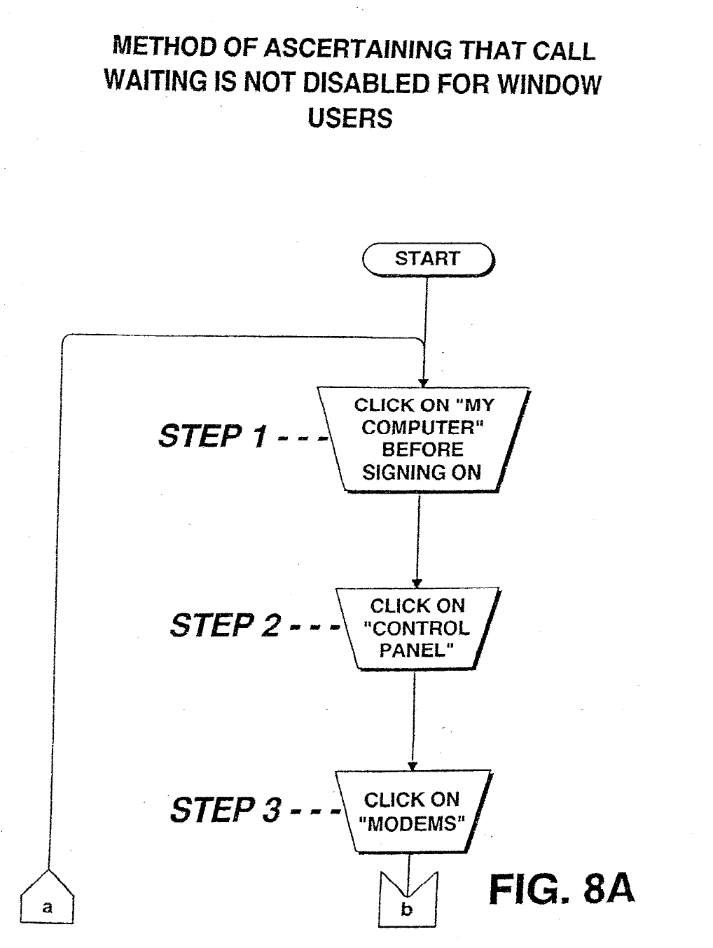

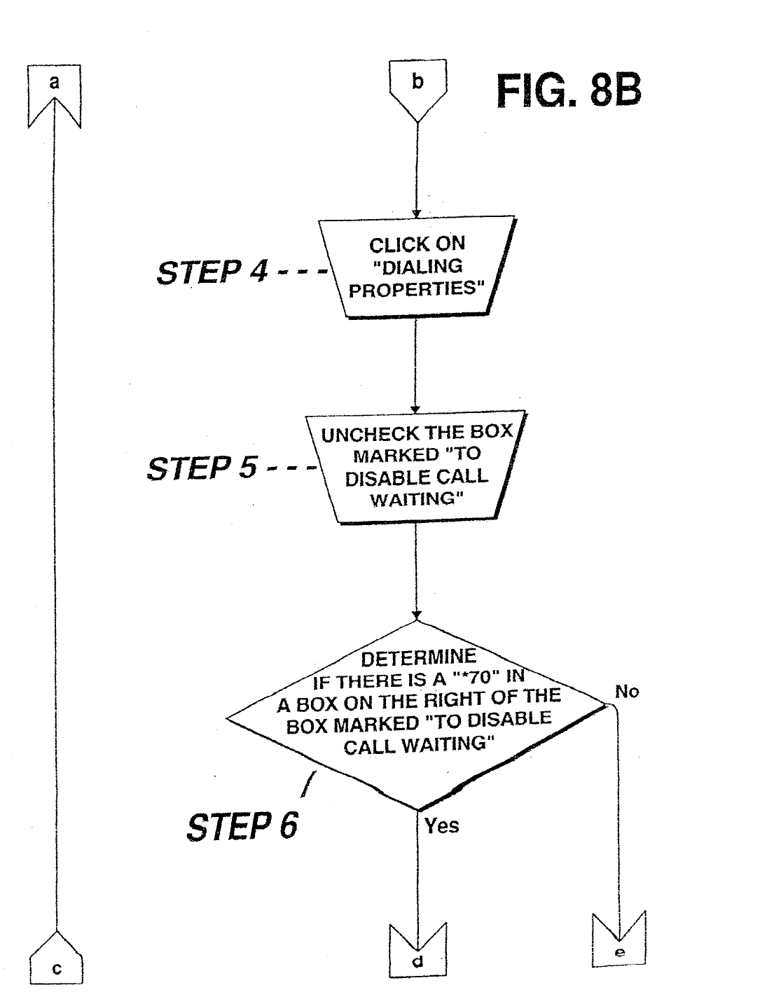

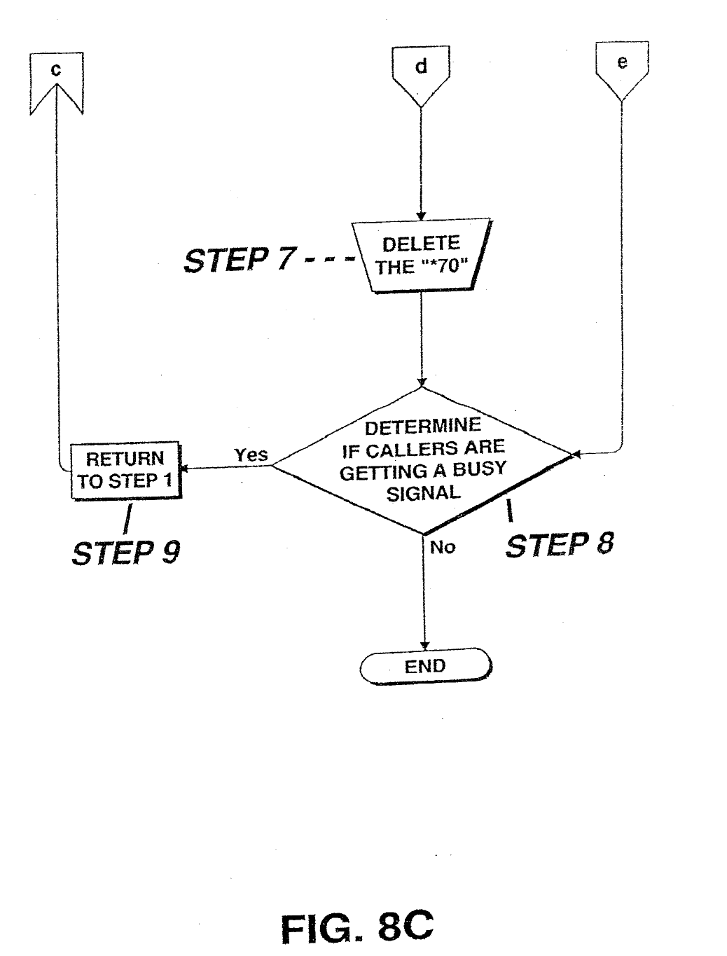

The method of ascertaining that call waiting is not disabled for window users can best be seen in FIGS. 8A-8C, and as such, will be discussed with reference thereto.

STEP 1: Click on “my computer” before signing on.

STEP 2: Click on “control panel”.

STEP 3: Click on “modems”.

STEP 4: Click on “dialing properties”.

STEP 5: Uncheck the box marked “to disable call waiting”.

STEP 6: Determine if there is a “*70” in a box on the right of the box marked “to disable call waiting”.

STEP 7: Delete the “*70”, if answer to STEP 6 is yes. There may also be a telephone icon on the control panel with the same check box.

STEP 8: Determine if callers are getting a busy signal.

STEP 9: Return to STEP 1, if answer to STEP 8 is yes.

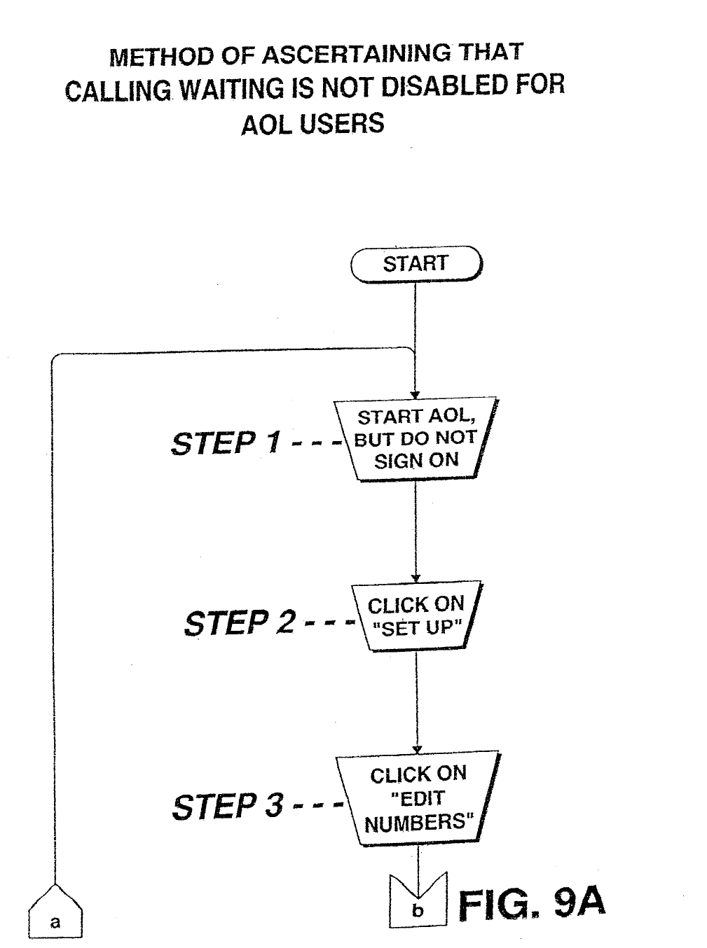

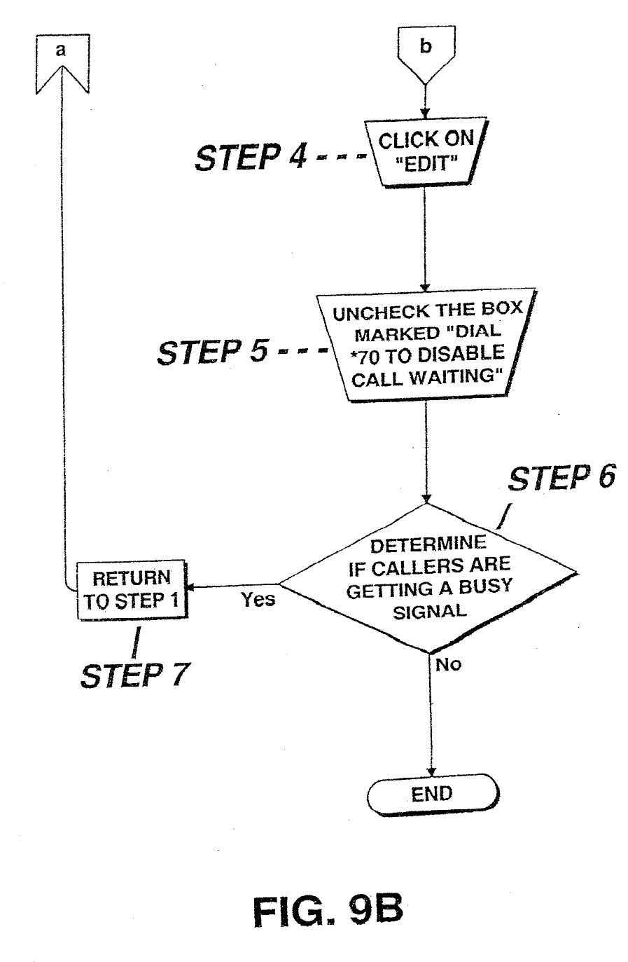

The method of ascertaining that calling waiting is not disabled for AOL users can best be seen in FIGS. 9A-9B, and as such, will be discussed with reference thereto.

STEP 1: Start AOL, but do not sign on.

STEP 2: Click on “set up”.

STEP 3: Click on “edit numbers”.

STEP 4: Click on “edit”.

STEP 5: Uncheck the box marked “dial *70 to disable call waiting”.

STEP 6: Determine if callers are getting a busy signal.

STEP 7: Return to STEP 1, if answer to STEP 6 is yes.

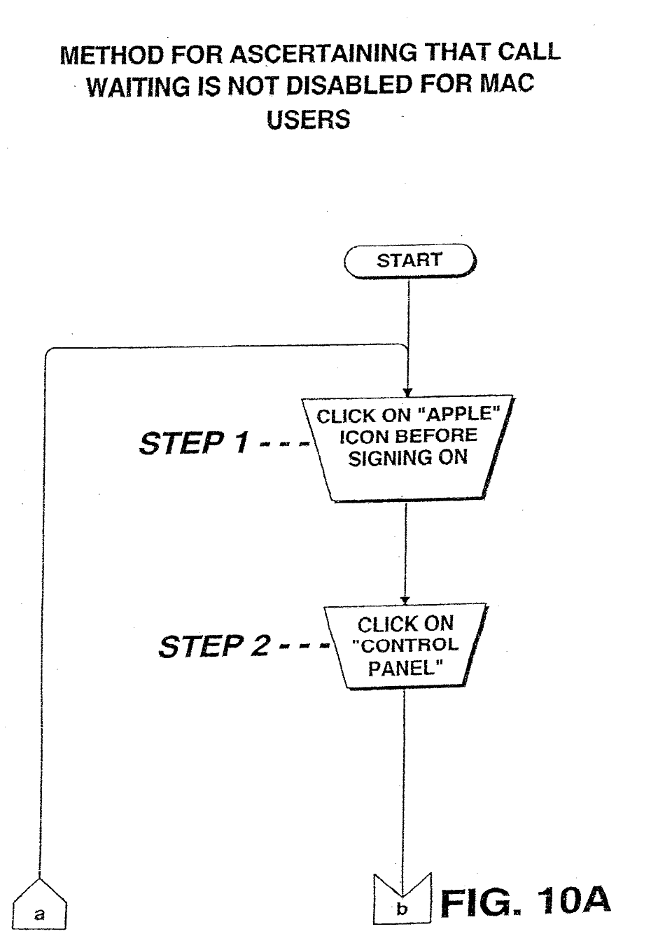

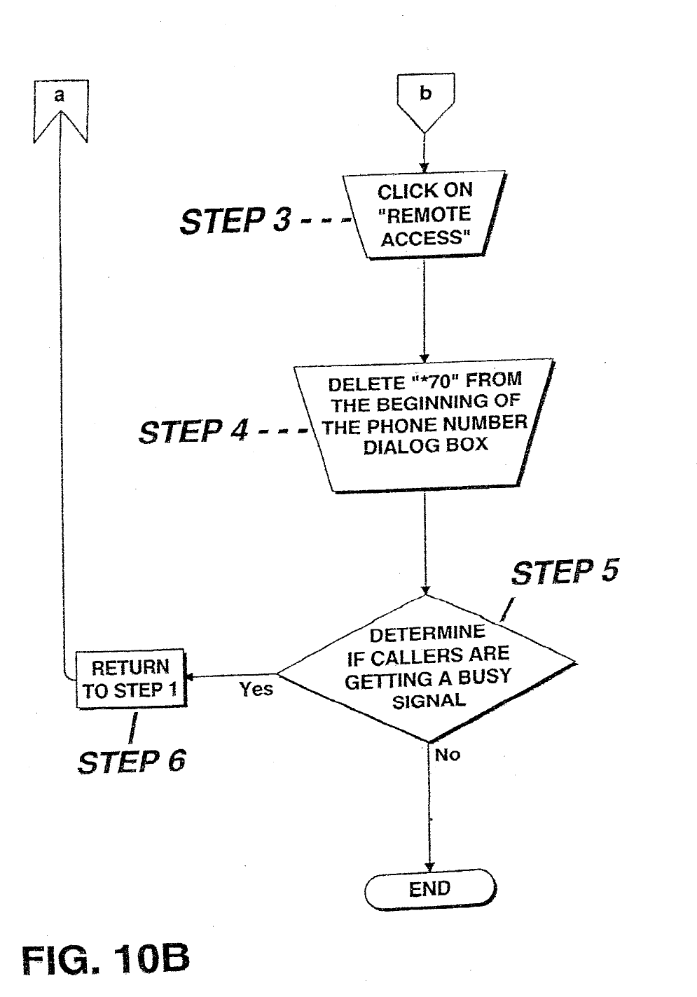

The method for ascertaining that call waiting is not disabled for MAC users can best be seen in FIGS. 10A-10B, and as such, will be discussed with reference thereto.

STEP 1: Click on the apple icon before signing on.

STEP 2: Click on “control panel”.

STEP 3: Click on “remote access”.

STEP 4: Delete “*70” from the beginning of the phone number dialog box.

STEP 5: Determine if callers are getting a busy signal.

STEP 6: Return to STEP 1, if answer to STEP 5 is yes.

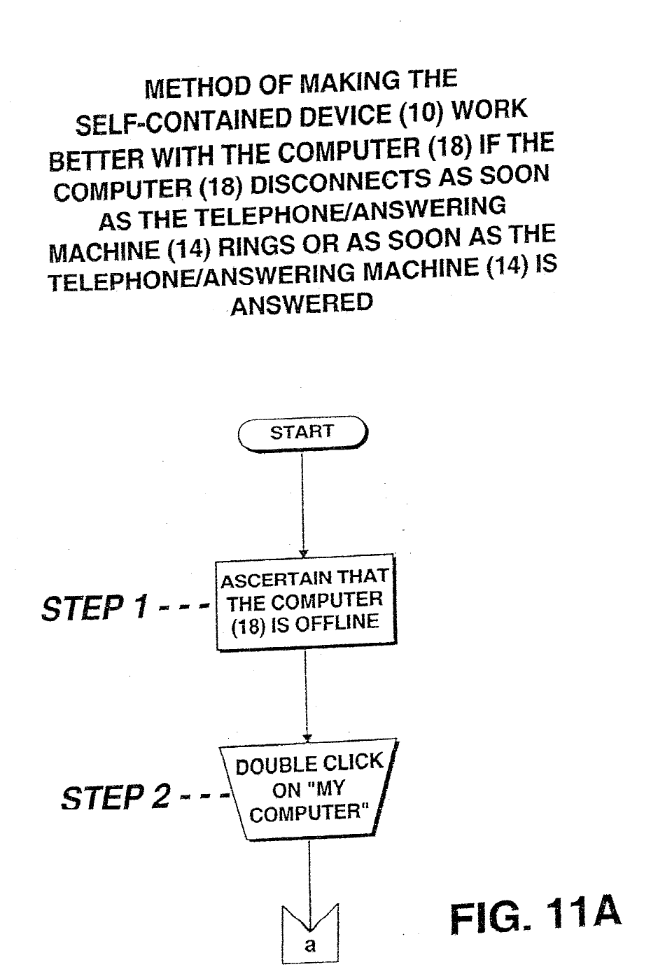

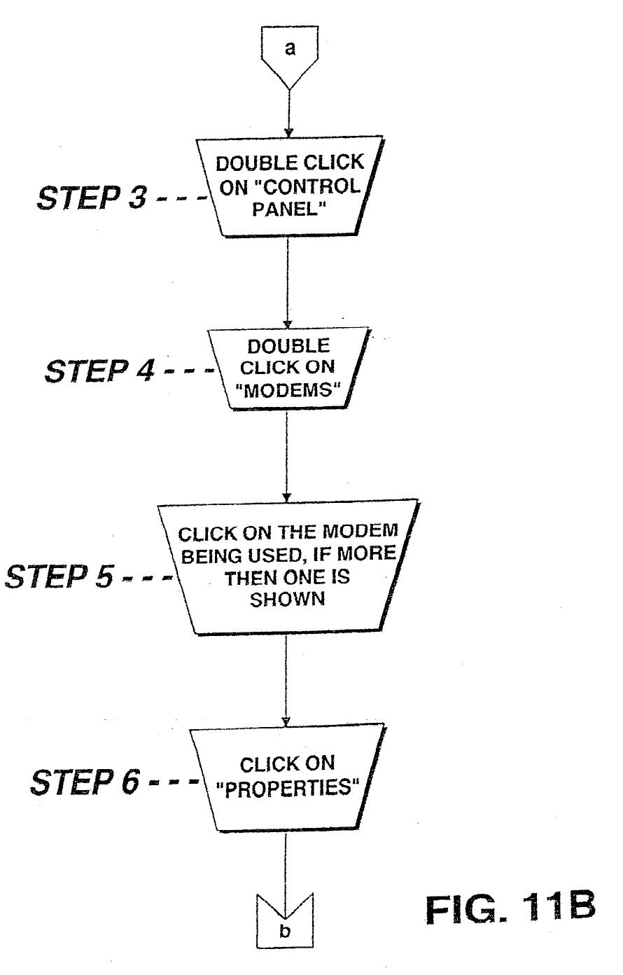

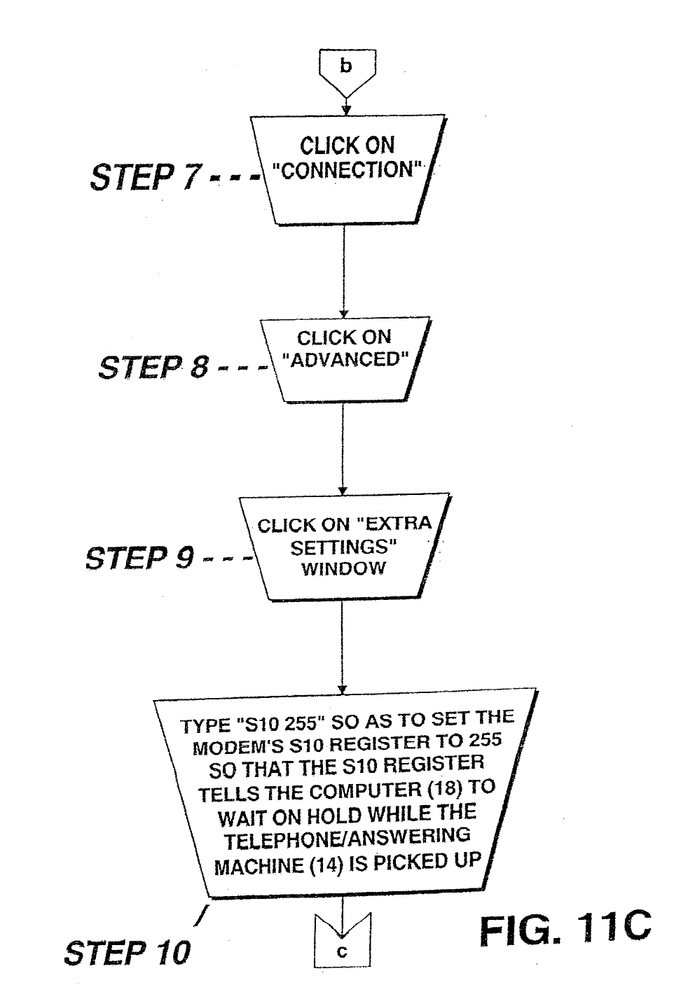

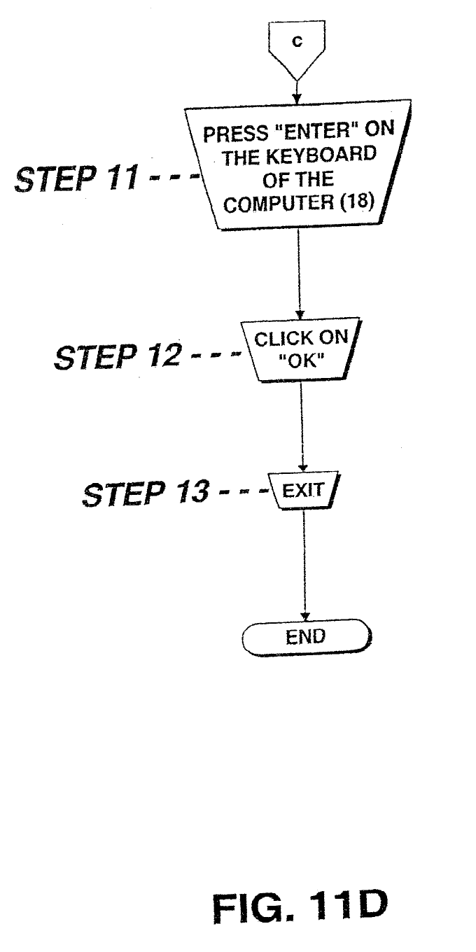

The method of making the self-contained device 10 work better with the computer 18 if the computer 18 disconnects as soon as the telephone/answering machine 14 rings or as soon as the telephone/answering machine 14 is answered can best be seen in FIGS. 11A-11D, and as such, will be discussed with reference thereto.

STEP 1: Ascertain that the computer 18 is offline.

STEP 2: Double click on “my computer”.

STEP 3: Double click on “control panel”.

STEP 4: Double click on “modems”.

STEP 5: Click on the modem being used, if more then one is shown.

STEP 6: Click on “properties”.

STEP 7: Click on “connection”.

STEP 8: Click on “advanced”.

STEP 9: Click on “extra settings” window.

STEP 10: Type “S10 255” so as to set the modems S10 register to 255 so that the S10 register tells the computer 18 to wait on hold while the telephone/answering machine 14 is picked up.

STEP 11: Press “enter” on the keyboard of the computer 18.

STEP 12: Click on “OK”. STEP 13: Exit.

During set-up of certain alternative embodiments of the invention, the user may in addition wish to direct the invention as to handling of incoming calls based upon recipient identity. Thus, the “Internet suspension” operation, STEP 7 of FIG. 4 may be enabled in certain cases and not in others, while the set-up operations of the self-contained device 10 may direct the methods of ringing/flashing the buzzer/call light 38 during STEP 4 of FIG. 4. In addition, STEP 5 of FIG. 4-6, in which the determination as to whether a call is to be answered or not is made, may be designated automatically.

This additional set-up may be carried out in hardware (for example, by means of buttons on the self-contained unit 10) or may be carried out by means of software on a personal computer, with the settings generated by the personal computer then downloaded to the self-contained device 10. Note that the setting information may then be present in self-contained device 10 even when a computer is turned off, disconnected, broken or otherwise unavailable during an incoming call. This facet of the self-contained operation is felt to be a marked improvement over devices teaching use of a personal computer to handle incoming calls.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A self-contained device for using a single telephone line to receive telephone calls for transmission to a telephone/answering machine while being simultaneously connectable to the Internet by a computer having a modem, said device comprising:
a) a single housing having a wall and a microprocessor;
b) a telephone/answering machine jack located on the wall of the single housing;
c) a modem jack located on the wall of the single housing;
d) a telephone line jack located on the wall of the single housing;
e) a DTMF tone generator able to generate generate DTMF tones on the such single telephone line;
f) a display located on the single housing.

2. The device of claim 1, wherein the DTMF tone generator is operatively connected to and controlled by the micro-processor.

3. The device of claim 1, further comprising:
h) a power supply having an input, a cable and an AC transformer adapted to connect to an AC power source.

4. The device of claim 3, wherein said power supply further has a 5 volt voltage regulator.

5. The device of claim 1, further comprising at least one telephone line isolation, amplification and filtration device located within the single housing; wherein the DTMF tone generator is operatively connected to the telephone line via the telephone line isolation, amplification and filtration device.

6. The device of claim 1, wherein the micro-processor responds to a user request for switching from one use of the telephone line to another use of the telephone line by generating the appropriate signals that the telephone exchange recognizes as requests to change lines.

7. The device of claim 6, wherein the appropriate signals that the telephone exchange recognizes as requests to change lines are selected from the group comprising: switch hook flash signals, DTMF tones, and combinations thereof.

8. The device of claim 6, wherein the appropriate signals that the telephone exchange recognizes as requests to change lines comprise: a switch hook flash signal followed by the DTMF tone corresponding to the number 2.

9. The device of claim 1, wherein the micro-processor responds to receipt of telephone call rings by automatically handling an incoming call.

10. The device of claim 9, wherein the automatic handling of the incoming call comprises one member selected from the group consisting of:
1) suspending Internet access;
2) routing the call to a telephone/answering machine;
3) sending to the user the telephone call ring information in order to allow the user to manually determine handling of the call;
4) ignoring the call;
5) routing the call to a modem; and
6) combinations thereof.

11. A method of receiving a telephone call comprising the steps of:
1) accessing a service provider by means of a telephone line having the call waiting feature;
2) monitoring the telephone line using a stand alone device;
3) upon receipt of a call waiting tone, determining if a call is to be answered;
4) if the call is to be answered, carrying out the following steps 5 through 7 inclusive:
5) flashing the telephone line, and following the flash by generating a DTMF tone on the telephone line, thereby automatically placing the service provider on hold and connecting to the caller;
6) monitoring the telephone line using the stand alone device until the telephone is hung up; and
7) flashing the telephone line, and following the flash by generating a DTMF tone on the telephone line, thereby automatically connecting to the service provider.

12. The method of claim 11, further comprising the steps of:
8) determining if the service provider has logged off of the computer; and
9) reconnecting to the service provider.

13. The method of claim 11, wherein the step of determining if a call is to be answered further comprises one member selected from the group consisting of: manually determining if the call is to be answered by awaiting user input, automatically determining if the call is to be answered by consulting information provided during the set-up of the device.
